(19) United States
(12) Patent Application Publication
(10) Pub. No.: US 2006/0269513 A1
(43) Pub. Date: Nov. 30, 2006

(54) Pheromone composition

(75) Inventor: George Henry Dodd, Aultbea (GB)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: Kiotech Limited, London (GB)

(21) Appl. No.: 11/500,535

(22) Filed: Aug. 8, 2006

Related U.S. Application Data
(63) Continuation of application No. 09/509,695, filed on Sep. 20, 2000, now abandoned.

(30) Foreign Application Priority Data
Oct. 1, 1997 (GB) 9720814.4

(51) Int. Cl. A01N 25/00

(52) U.S. Cl. 424/84

(57) ABSTRACT

The invention provides compositions formulated to attract fish, comprising at least one human female pheromone such as trimethylamine, pyrroline and salts thereof, steroids of the androstene family such as 5-alpha-androst-16-en-3-α-ol, heterocyclic compounds such as indole and skatole and alkanoic acid compounds such as 4-methyloctanoic acid. Compositions can be formulated as liquids for direct application to bait, hooks or flies. Plastic bait can be manufactured including the composition. The composition can be used to attract fish by fishermen and anglers or to guide fish into paths to enable them to cross dams.

This is a continuation of application Ser. No. 09/509,695, filed Sep. 20, 2000, which is a 371 of PCT/GB98/02941. The entire disclosure of the aforementioned applications are incorporated herein by reference.

The invention relates to compositions formulated to attract fish, in order to capture them. More particularly the composition may be used in a liquid form to be applied onto or into bait, lures or flies which are used by anglers and commercial fishermen alike.

Angling and fishing are sports which attract a large number of people. A wide range of bait, lures and flies are marketed at these persons in order to provide them with more success in catching fish.

Some organic compounds are known to be active in the feeding response of some species by enhancing feeding or attracting fish to a general area. They are known to occur at low concentration levels in crustacea and also in a range of decomposing animals. Such compounds are small organic odorants.

It has been reported that women have a greater success rate in catching salmon than male anglers (see Salmon and women, W. Paterson & P. Behan, published by H, F & G Witherby Ltd 1990).

It is an object of the invention to provide a composition showing enhanced attracting effects on fish.

It is another object of the invention to provide a method to attract fish by using the composition of the invention.

It is a further object of the invention to provide the composition of the invention to be applied to bait (live or dead), lures or flies (dry or wet) used in the practise of angling or commercial fishing.

It has surprisingly been found that compositions containing at least one human female pheromone presents an unexpectedly good attractive effect on fish, and particularly on salmon. Such compositions may be applied on any kind of bait used by anglers and fishermen.

Herein the term “pheromone” is taken to include amines such as trimethylamine and pyrroline, and salts thereof, steroids of the androstene family such as 5-alpha-androst-16-en-3-α-ol, heterocyclic compounds including nitrogen and/or sulphur such as indole and skatole and alkanoic acid compounds such as 4-methyloctanoic acid.

The objects of the invention are achieved with a fish attracting composition comprising at least one human female pheromone, or a synthetic nature-similar version of the latter.

In one embodiment the invention provides at least one female human pheromone together with an acceptable carrier.

Alternatively the composition can comprise a synthetic female pheromone with a carrier. Preferably the carrier solubilises the compound.

Preferred carriers include aliphatic alcohols such as ethanol, monoethylene glycol and propylene glycol.

It is preferred that the pheromone used in the composition of the invention be at least trimethylamine or one volatile steroid of the androstene family together with at least one compound chosen from a complex array of alkanoic acids, including those having a carbon atom number ranging from C4 to C5 and especially substituted acids having a carbon atom number ranging from C8 to C10.

A particularly preferred composition comprises at least one salt of trimethylamine (typically the hydrochloride) and 5-alpha-androst-16-en-3-α-ol.

A preferred composition according to the invention may comprise in association with nature-similar versions of human female pheromones, a suite of other potent aroma chemicals (referred to herein as Key Impact Odorants [KIOs]) which occur in both fresh and decomposing animal tisue.

These other KIOs can be special amines and associated heterocyclic compounds including nitrogen and sulphur such as indole and skatole. It is also preferred that the odorant compounds be provided with concentrations of several order of magnitude higher than the ones which are found in conventional bait.

The composition of the invention can be used in various embodiments.

In one embodiment the composition is a liquid which bait, lure, fly, ground bait and/or hooks can be dipped into or the liquid can be poured onto the bait, lure, fly, ground bait and/or hooks.

The composition of the invention may also be formulated as a spray to allow easy manipulation by the users and could either be hand pumped or gas driven.

In a preferred embodiment the composition is formulated to be injected into bait.

Alternatively the composition can be incorporated into plastic bait.

To attract fish one may apply the composition of the invention on a bait or a suitable support and provide it in area where fish are used to be found.

The composition may also be applied directly onto bare hooks.

The composition of the invention can be formulated for a wide range of applications including combining with floatant, spraying flies, combining with greasing or degreasing agents to enable bait to float or sink as required.

The formulation can also be combined with ground bait and dried for storage purposes.

Formulations of the present invention are surprisingly effective in aqueous solution. Whereas a preferred carrier is ethanol and a basic formulation can include a salt of trimethylamine in ethanol, in use the formulation produces trimethylamine on contact with water. In fishing, the formulation will be vastly diluted in water and therefore it is most surprising that use of the formulation can effectively enhance fishing.

The pheromones which may be advantageously used in a composition according to the invention include the following:

Trimethylamine (TMA) (as derived from a salt of trimethylamine such as the hydrochloride) is an exceptionally interesting KIO pheromone. It occurs on human skin and is especially important for females. It is the characteristic odour of a menstruating female. The odour profile is distinctive and is not shared by closely related amines such as, for example, dimethylamine. The aroma is that of fresh shell fish at the threshold level. In fact it is thought that most of the charm of oyster, scallops and the like comes from TMA. The aroma changes with increasing concentration and becomes increasingly unpleasant. At a high level TMA will be perceived as an off-odour in shell fish and the like, and as a sign of lack of hygiene in a human subject.

The threshold concentration for humans is about 1 ppb (1 part in 10⁹)—this is low by olfactory standards. There is, in fact, great individual variability and the concentration varies around the mean figure by about 3 orders of magnitude. This gives rise to great variability; for example, a crustacean may appear delightful to a person of high threshold but may be abhorrent to a person of low threshold (skin sensitivity). See in that matter “Ageing and the Sense of Smell” C, Van Toller, G H Dodd & A Billing, Charles T Thomas, Publisher, Springfield, Ill., USA, 1985.

Another interesting pheromone to be used in the fish-attracting composition is 1-Pyrroline. This is a rare and little studied human pheromone. It is unstable and therefore very difficult to study. It is formed by oxidation of precursor molecules such as 1,4-diaminobutane and 1,4-diaminopentane. These amines occur in a variety of human tissues, and can be formed from appropriate amino acids.

In order to overcome the instability problem when 1-Pyrroline is to be used in a fish-attracting composition of the invention, the parent amines (i.e. the above mentioned precursors) are incorporated at a high level in the composition. They will slowly oxidize and release the unstable active odorant.

These parent amines are also called respectively, putrescine and cadaverine, for obvious olfactory reasons and occurred in decomposing animal tissue. The human threshold is in the ppb range.

A further preferred pheromone is the 5-alpha-androst-16-en-3-α-ol. This pheromone is a well-known pheromone which is found in both males and females but is thought to be more important for women (in contrast to the related steroid pheromone, alpha-androstenone). The threshold for human is in the low ppb range. The odour is usually described as musky.

A still further preferred pheromone is 4-Methyloctanoic acid which is characteristic of the scalp odour and may be found in gamey meat. The threshold is unusually low for a fatty acid and is in the region of ppb. It is has been reported that women are much more sensitive to this odorant than men.

A particular composition according to the invention has been tested in fishing experiments on the River Ness, other rivers in the Highlands, and in Ireland and on a variety of Lochs. Positive results have been obtained.

The composition of this particular non-limiting composition is the following:

| | | Amount Required for | |
|---|---|---|---|
| | | 1000 litres of | |
| Component No | Name | solvent (ethanol) | |
| 1 | Trimethylamine | 7 | kg |
| | hydrochloride | | |
| 2 | 1,4 diaminobutane | 0.7 | kg |
| 3 | 1,4 diaminopentane | 0.1 | kg |
| 4 | indole | 50 | grm |
| 5 | skatole | 40 | grm |
| 6 | isovaleric acid | 40 | grm |
| 7 | 4-methyloctanoic acid | 10 | grm |
| 8 | 4-methylnonanoic acid | 5 | grm |
| 9 | phenylacetic acid | 20 | grm |
| 10 | 2-methyl-E-butenoic acid | 5 | grm |
| 11 | 4-methylpentanoic acid | 10 | grm |
| 12 | 2-methyl-2-pentenoic acid | 10 | grm |

| | | |
|---|---|---|
| 13 | 5-alpha-androst-16-en-3-α-ol | 60 mg-6 g |

A more general preferred composition comprises

| | | Amount Required for |
|---|---|---|
| Component | | 1000 litres of |
| No | Name | solvent |
| 1 | KIO Pheromone | 0.05-50 kg |
| 2 | Alkanoic acid | 5 g-1.5 kg |
| 3 | Amines | 0.1 kg-8 kg |

Even if a special emphasis has been given on the utility of the composition in order to ease fishing it is understood that the composition to attract fish as above described may be used for other purposes. For example it may be used to attract salmon into special paths provided in order to help them to cross dams, waterfalls or other obstructions.

Experimental Study

An initial study was carried out to establish a relationship between the use of female pheremones at a chosen concentration and the increase in the catch of salmon, either by fish size or numbers caught using the conventional rod and line method with a selected range of hand tied salmon flies.

Three specialist salmon fly fishermen were chosen who regularly fished prime salmon rivers, have extensive combined specialist knowledge gained from 20 years of fly fishing, fish a regular pattern over the entire season, have experience of observing changes and variations in fish runs and catch methods and were willing to comply with strict rules with regard to reporting procedures.

Rivers chosen for the study covered the entire salmon cycle, i.e Spring-Summer and Autumn salmon runs, January-September 1997.

Results

Some interesting findings came to light at the season end:

Of the three subjects cho.'sen, all had a significant change in their catch pattern, (1) 43 salmon caught (2) 75 salmon caught (3) 15 salmon caught.

Subjects (1) and (2) fly fished the middle/upper reaches of a major salmon river. The river is world famous for the range of salmon fishing available. Spring salmon run (10-251bs) is moderate. Large runs of Summer grilse (3-8 lbs) and a good run of Autumn salmon (10-30 lbs).

Subject (3) fly fished a major East Coast spring salmon fishery (10-30 lbs) This river has small runs of summer salmon owing to licensed commercial fishing in estuary waters.

In all cases the reports,.returned were similar with more consistent catches particulary when fish were in holding pools (when water levels receded after floods).

Catch summary (Salmon caught)

| Subject | 1996 | 1997 |
|---|---|---|
| (1) | 37 | 75 |
| (2) | 18 | 43 |
| (3) | 9 | 15 |

No exceptional fish size was reported over that of the 1996 season.

Water levels for 1997 were consistently high by comparison to 1996 resulting in concentration of several salmon runs in holding pools throughout the entire river system.

Current information on official commercial salmon catch ventures for 1997 would indicate a 20% reduction on the 1996 season.

Water temperatures were slightly higher than previous years.

Most salmon for this study were caught on an imitation shrimp fly dressing of various sizes.

All subjects chosen for this study were male with average age of 45 years.

All subjects chosen tie their own flies, however, similar selected shrimp/prawn flies were distributed to all.

Salmon flies used were purchased from local fishing tackle shops.

The final results of this initial trial study would indicate some relationship between the choice of fly with sample female pheromone and the traditional fly fishing method.

One fisherman has fished for Sea Bass (commonly known as Salmon Bass) off the east coast for many years, with varying success. This specialist fishing activity fished off chosen rocky points in July/August would normally yield 1-2 fish per outing. This year, using identical fishing lures, substantially improved bass catches were recorded with better than average sizes using the female pheromone formulation described herein. Other specialist bass anglers fishing the same waters did not use the formulation and did not return above average catches.

I claim:

1. A fish attracting composition comprising at least one human female pheromone, or a synthetic version thereof, the composition further comprising at least one compound selected from the group consisting of alkanoic acids having a carbon atom number ranging from C₄ to C₅ and substituted alkanoic acids having a carbon atom number ranging from C₈ to C₁₀.

2. A composition as claimed in claim 1, wherein the pheromone is trimethylamine or a salt thereof.

3. A composition as claimed in claim 1, further comprising an acceptable carrier.

4. A composition as claimed in claim 3, wherein the carrier is an aliphatic alcohol or propylene glycol.

5. A composition as claimed in claim 1, wherein the alkanoic acid comprises isovaleric acid and the female pheromone comprises at least one salt of trimethylamine.

6. A composition as claimed in claim 1, wherein the composition is a liquid.

7. A composition as claimed in claim 1, which is formulated for injection into bait.

8. A composition as claimed in claim 1, which is formulated as a spray.

9. A composition according to claim 1, wherein the substituted alkanoic acid is 4-methyloctanoic acid.

10. A composition as claimed in claim 4, wherein the human female pheromone comprises trimethylamine hydrochloride and the alkanoic acid comprises isovaleric acid.

11. A composition as claimed in claim 10, wherein the composition is a liquid.

12. A composition as claimed in claim 11, which is formulated for injection into bait.

13. A composition as claimed in claim 11, which is formulated as a spray.

14. Plastic bait including the composition as claimed in claim 1.

15. Plastic bait including the composition as claimed in claim 3.

16. Plastic bait including the composition as claimed in claim 4.

17. Plastic bait including the composition as claimed in claim 11.

18. Plastic bait including the composition as claimed in claim 12.

19. Dried ground bait including the composition as claimed in claim 1.

20. Dried ground bait including the composition as claimed in claim 3.

21. Dried ground bait including the composition as claimed in claim 11.

22. A fishing or angling hook for fishing or angling, to which is applied the fish attracting composition according to claim 1, wherein the composition is a liquid.

23. Fish bait, lure or flies for fishing or angling to which is applied a fish attracting composition comprising a pheromone, a substituted alkanoic acid having a carbon atom number in the range C8 to C10 and amines, wherein said pheromone is trimethylamine, indole or skatole.

24. The fish bait, lure or flies according to claim 23 wherein the alkanoic acid is 4-methyloctanoic acid.

25. A fishing or angling hook for fishing or angling to which is applied a fish attracting composition, wherein the composition is a liquid comprising a pheromone, a substituted alkanoic acid having a carbon atom number in the range C8 to C10 and amines, wherein said pheromone is trimethylamine, indole or skatole.

26. The hook according to claim 25, wherein the alkanoic acid is 4-methyloctanoic acid.
